(19) United States
(12) Patent Application Publication
(10) Pub. No.: US 2018/0312014 A1
(43) Pub. Date: Nov. 1, 2018

(54) CONDUCTIVE SPLICING CEMENT

(71) Applicant: Bridgestone Americas Tire Operations, LLC, Nashville, TN (US)

(72) Inventors: Samuel O. Givens, Copley, OH (US); Ross W. Widenor, Munroe Falls, OH (US)

(21) Appl. No.: 15/735,627

(22) PCT Filed: Jun. 15, 2015
(86) PCT No.: PCT/US15/35755

§ 371 Date: Dec. 12, 2017

(51) Int. Cl. B60C 19/08; C08L 9/00; C08L 7/00

(52) U.S. Cl. CPC B60C 19/08; C08L 7/00; C08L 9/00

(57) ABSTRACT

Provided is a conductive cement composition including a carbon black, an elastomer, a curative, an accelerant, and a tackifying resin. Also provided is a tire tread including a conductive cement splice, the conductive cement splice including a conductive cement composition. Also provided is a kit including a conductive cement composition.

### BACKGROUND

Tires mounted on a vehicle often generate static electricity as a result of internal friction during running of the tire. Tires mounted on a vehicle often include tread compounds including silica, resulting in a tire tread having a higher electrical resistance. As a result of tire treads having a higher electrical resistance, tires may not readily discharge built up static electricity, which may interfere with a vehicle's electronic devices, cause dangerous sparking near combustible materials, or result in unpleasant discharge to one operating the vehicle.

Many tires include conductive materials oriented about the circumference of the tire's tread in order to permit discharge of built up electricity into the ground. However, such conductive materials often require undesirable or costly modification to a tire tread or tire manufacturing process.

What is needed is a tire having a conductive element easily installed into the tire tread with minimal modification.

### SUMMARY

In one embodiment, a conductive cement composition is provided. The conductive cement composition may include a carbon black. The conductive cement composition may include an elastomer. The conductive cement composition may include a curative. The conductive cement composition may include an accelerant. The conductive cement composition may include a tackifying resin.

In one embodiment, a tire tread is provided. The tire tread may include a set of tread ends. The tire tread may include a road-contacting surface. The tire tread may include an inner component-contacting surface. The inner component-contacting surface may be substantially opposite the road-contacting surface. The tire tread may include a set of splice surfaces. The set of splice surfaces may terminate the set of tread ends. The tire tread may include a conductive cement splice. The conductive cement splice may include a conductive cement composition. The conductive cement composition may include a conductive material. The tire tread may include a lateral outer edge. The tire tread may include a later inner edge. The conductive cement splice may extend at least partially from the lateral outer edge to the lateral inner edge. The conductive cement splice may secure one or more of the set of tread ends and the set of splice surfaces.

In one embodiment, a kit is provided. The kit may include a conductive cement composition. The conductive cement composition may include a carbon black. The conductive cement composition may include an elastomer. The conductive cement composition may include a curative. The conductive cement composition may include an accelerant. The conductive cement composition may include a tackifying resin.

### BRIEF DESCRIPTION OF THE DRAWINGS

The accompanying figures, together with the detailed description provided below, describe example embodiments of the claimed invention.

FIG. 1A is a perspective view of a generic tire illustrating a tire tread 100 prior to splicing of a set of tread ends 102 with a cement.

FIG. 1B is a perspective view of a generic tire illustrating a tire tread 100 after splicing of a set of tread ends 102 with a cement 114.

FIG. 1C is a sectional view of a tire including a tire tread 100.

FIG. 2 illustrates a kit 200 including a conductive cement composition 202.

FIG. 3 is a graph illustrating the resistivity of a conductive cement composition with respect to varying amounts of carbon black.

FIG. 4 is a graph illustrating the adhesive properties of a conductive cement composition with respect to varying amounts of carbon black.

### DETAILED DESCRIPTION

In various embodiments, a conductive cement composition is provided. The conductive cement composition may include a carbon black. The conductive cement composition may include an elastomer. The conductive cement composition may include a curative. The conductive cement composition may include an accelerant. The conductive cement composition may include a tackifying resin.

The carbon black may be present in the conductive cement composition in an amount in wt % of at least about one or more of: 25, 27, 29, 30, 32, 34, 36, 38, and 40. The carbon black may be present in the conductive cement composition in amount in wt % between any of the preceding values, for example, between about 25 and about 27, or between about 29 and about 34. The carbon black may be present in the conductive cement composition in less than about 25 wt %. The carbon black may be present in the conductive cement composition in greater than about 40 wt %. The carbon black may be present in the conductive cement composition in an amount in phr of at least about one or more of: 25, 30, 35, 40, 45, 50, 55, 60, 65, 70, and 75. The carbon black may be present in the conductive cement composition in an amount in phr between any of the preceding values, for example, between about 25 and about 30, or between about 30 and about 50. The carbon black may be present in the conductive cement composition in less than about 25 phr. The carbon black may be present in the conductive cement composition in greater than about 75 phr.

The carbon black may be any grade carbon black. The carbon black may be any grade carbon black, for example, N134, N234, N330, N550, N660, N774, or N990 grade carbon black, or combinations thereof. The carbon black may be a solution in an organic solvent. The carbon black may be a suspension in an organic solvent. The organic solvent may include a hydrocarbon solvent, for example.

The carbon black may be a one or more of a suspension, a dispersion, and an emulsion in water. The carbon black as one or more of a suspension, a dispersion, and an emulsion in water may include one or more of an anionic surfactant and a nonionic surfactant. The anionic surfactant may include a sulfate, for example. The anionic surfactant may include a carboxylate, for example. The nonionic surfactant may include a glycol, for example. The carbon black may include, for example, Aquablak® 5106 (Solution Dispersions, Cynthiana, Ky.), Aquablak® 6950 (Solution Dispersions, Cynthiana, Ky.), Aquablak® 8361 (Solution Dispersions, Cynthiana, Ky.), or a combination thereof.

The elastomer may be present in the conductive cement composition in an amount in wt % of at least about one or more of: 45, 50, 55, and 60. The elastomer may be present in the conductive cement composition in an amount in wt % between any of the preceding values, for example, between about 45 and about 50, or between about 50 and about 60. The elastomer may be present in the conductive cement composition in less than about 45 wt %. The elastomer may be present in the conductive cement composition greater than about 60 wt %. The elastomer may include an unsaturated polymer. The elastomer may include a synthetic rubber. The elastomer may include a natural rubber. The elastomer may include a latex. The elastomer may include polyisoprene, polybutadiene, polystyrene butadiene, or a combination thereof.

The curative may be present in the conductive cement composition in an amount in wt % of at least about one or more of: 2.7, 3.0, 3.3, 3.6, and 3.9. The curative may be present in the conductive cement composition in an amount in wt % between any of the preceding values, for example, between about 2.7 and about 3.0, or between about 3.0 and about 3.6. The curative may be present in the conductive cement composition in less than about 2.7 wt %. The curative may be present in the conductive cement composition in greater than about 3.9 wt %. The curative may include sulfur. The curative may be elemental sulfur.

The accelerant may be present in the conductive cement composition in an amount in wt % of at least about one or more of: 0.1, 0.2, 0.3, 0.4, and 0.5. The accelerant may be present in the conductive cement composition in an amount in wt % between any of the preceding values, for example, between about 0.1 and about 0.2, or between about 0.3 and about 0.5. The accelerant may be present in the conductive cement composition in less than about 0.1 wt %. The accelerant may be present in the conductive cement composition in greater than 0.5 wt %. The accelerant may include one or more of: a thiazole, a guanidine, an aldehyde amine, a sulfenamide, a dithiocarbamate, a thiuram sulfide, a xanthate, and the like. The accelerant may include mercaptobenzothiazole disulfide (MBTS), for example.

The tackifying resin may be present in the conductive cement composition in an amount in wt % of at least about one or more of: 3, 5, 7, 9, and 11. The tackifying resin may be present in the conductive cement composition in an amount in wt % between any of the preceding values, for example, between about 3 and about 5, or between about 7 and about 9. The tackifying resin may be present in the conductive cement composition in less than about 3 wt %. The tackifying resin may be present in the conductive cement composition in greater than about 11 wt %. The tackifying resin may include one or more of: a rosin, a terpene resin, an aliphatic resin, a cycloaliphatic resin, an aromatic resin, a phenolic hydrocarbon resin, and the like.

The tackifying resin may be a solution in an organic solvent. The tackifying resin may be a suspension in an organic solvent. The organic solvent may be a hydrocarbon solvent, for example.

The tackifying resin may be a one or more of a suspension, a dispersion, and an emulsion in water. The tackifying resin as one or more of a suspension, a dispersion, and an emulsion in water may include one or more of an anionic surfactant and a nonionic surfactant. The anionic surfactant may include a sulfate, for example. The anionic surfactant may include a carboxylate, for example. The nonionic surfactant may include a glycol, for example. The tackifying resin may include Tacolyn™ 5070 (Eastman Chemical Co., Kingsport, Tenn.), for example. The tackifying resin may include Koresin® (BASF, Florham Park, N.J.), for example.

The conductive cement composition may include an essential oil. The essential oil may be present in the conductive cement composition in an amount in wt % of at least about one or more of: 1.3, 1.5, 1.7, 1.9, and 2.1. The essential oil may be present in the conductive cement composition in an amount in wt % between any of the preceding values, for example, between about 1.3 and about 1.5, or between about 1.3 and about 1.7. The essential oil may be present in the conductive cement composition in less than about 1.3 wt %. The essential oil may be present in the conductive cement composition in greater than about 2.1 wt %. The essential oil may include limonene. The essential oil may include one or more of orange oil, lemon oil, lime oil, grapefruit oil, and bergamot oil.

The conductive cement composition may be neutral or basic. The conductive cement composition may include a pH value of at least about one or more of: 7, 8, 9, 10, 11, and 12. The conductive cement composition may include a pH value between any of the preceding values, for example, between about 7 and about 9, or between about 8 and about 11.

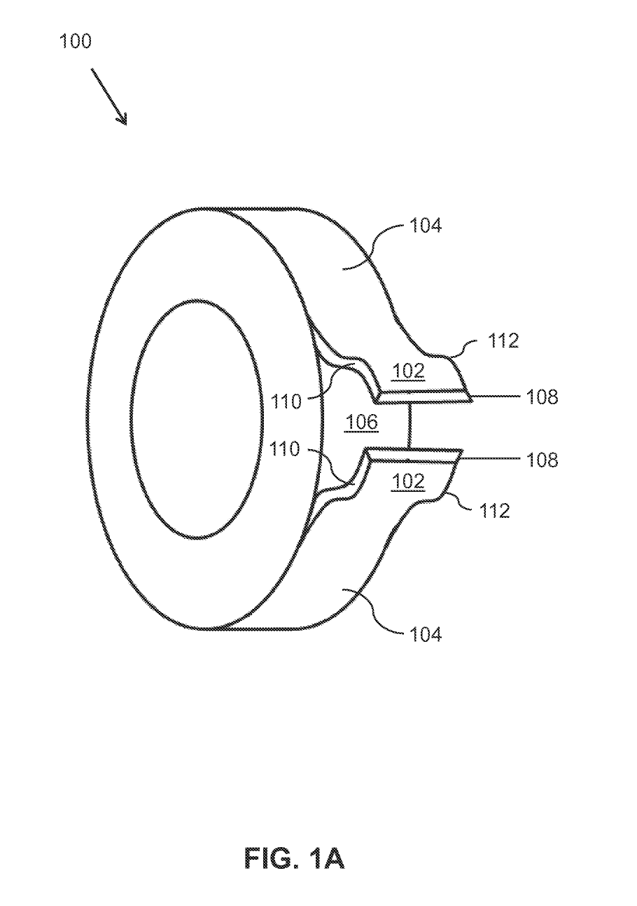

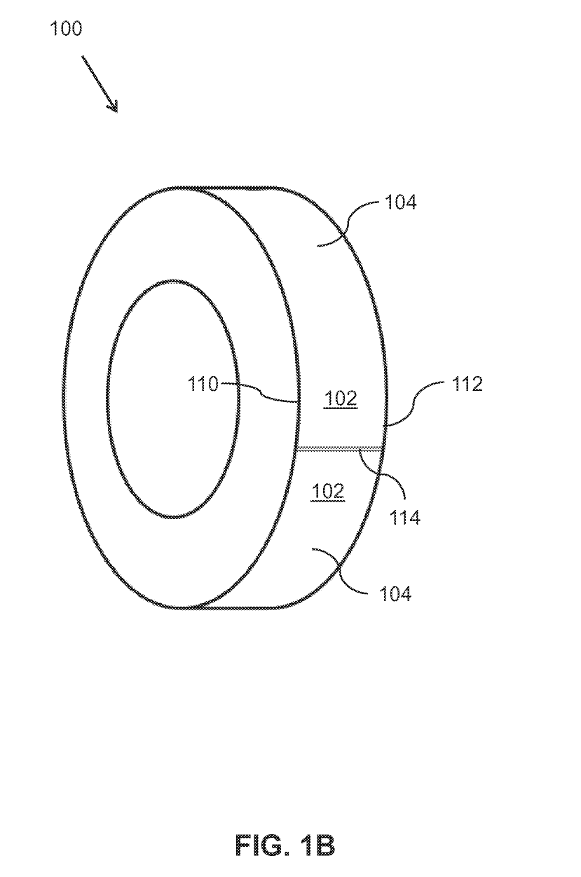

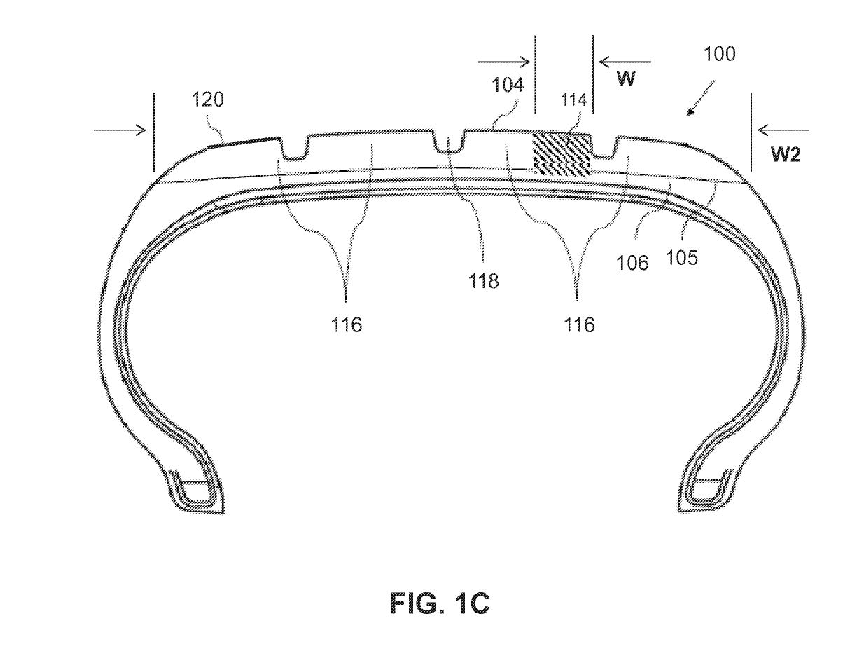

In various embodiments, a tire tread 100 is provided. Tire tread 100 may include a set of tread ends 102. FIG. 1A shows a tire with tire tread 100 prior to splicing of the set of tread ends 102 to one another. Tire tread 100 may include a road-contacting surface 104. Tire tread 100 may include an inner component-contacting surface 105 (viewable in FIG. 1C). The inner component-contacting surface may contact an outer carcass portion 106. The set of tread ends 102 may include a set of splice surfaces 108. Tire tread 100 may include a lateral outer edge 110 and a lateral inner edge 112.

FIG. 1B shows a tire with tire tread 100 after splicing of the set of tread ends 102 to one another. Tire tread 100 may include a conductive cement splice 114. Conductive cement splice 114 may extend at least partially from lateral outer edge 110 to lateral inner edge 112. Conductive cement splice 114 may extend completely from lateral outer edge 110 to lateral inner edge 112. Conductive cement splice 114 may extend from road-contacting surface 104 to inner component-contacting surface 105 (viewable in FIG. 1C) of tire tread 100. Conductive cement splice 114 may contact outer carcass portion 106. Conductive cement splice 114 may extend from road-contacting surface 104 to outer carcass portion 106. Conductive cement splice 114 may form an electrically conductive path between road-contacting surface 104 to outer carcass portion 106.

FIG. 1C shows a sectional view of the set of tread ends 102 and conductive cement splice 114 of tire tread 100. Tire tread 100 may include a pattern upon road-contacting surface 104. The pattern may include one or more of at least one tread rib and at least one tread block 116. The pattern may include at least one groove 118. One or more of the at least one tread rib and the at least one tread block may include a radially outermost portion 120. Conductive cement splice 114 may extend to radially outermost portion 120.

Conductive cement splice 114 may include a conductive material. Conductive cement splice 114 may include a carbon black. Conductive cement splice 114 may include a cured elastomer. Conductive cement splice 114 may include a tackifying resin.

Tire tread 100 may be a green tread. The green tread may be spliced with conductive cement splice 114 and subsequently cured and molded. Tire tread 100 may be a cured tread. The cured tread may include a tread pattern. The cured tread may be spliced with conductive cement splice 114 in a retreading process. Tire tread 100 may be a partially cured tread. The partially cured tread may include at least a partial tread pattern. The partially cured tread may be spliced with conductive cement splice 114 in a retreading process, and subsequently cured.

Conductive cement splice 114 may result from curing of a conductive cement composition. The conductive cement composition may include a conductive material. The conductive material may include a carbon black. The conductive cement composition may include an elastomer. The conductive cement composition may include a curative. The conductive cement composition may include an accelerant. The conductive cement composition may include a tackifying resin. The conductive cement composition may include an essential oil.

The carbon black may be present in the conductive cement composition in an amount in wt % of at least about one or more of: 25, 27, 29, 30, 32, 34, 36, 38, and 40. The carbon black may be present in the conductive cement composition in an amount in wt % between any of the preceding values, for example, between about 29 and about 32, or between about 25 and about 34. The carbon black may be present in the conductive cement composition in less than about 25 wt %. The carbon black may be present in the conductive cement composition in greater than about 40 wt %. The carbon black may be present in the conductive cement composition in an amount in phr of at least about one or more of: 25, 30, 35, 40, 45, 50, 55, 60, 65, 70, and 75. The carbon black may be present in the conductive cement composition in an amount in phr between any of the preceding values, for example, between about 30 and about 40, or between about 25 and about 50. The carbon black may be present in the conductive cement composition in less than about 25 phr. The carbon black may be present in the conductive cement composition in greater than about 75 phr.

The carbon black may be any grade carbon black. The carbon black may be any grade carbon black, for example, N134, N234, N330, N550, N660, N774, or N990 grade carbon black, or combinations thereof. The carbon black may be a solution in an organic solvent. The carbon black may be a suspension in an organic solvent. The organic solvent may be a hydrocarbon solvent, for example.

The carbon black may be a one or more of a suspension, a dispersion, and an emulsion in water. The carbon black as one or more of a suspension, a dispersion, and an emulsion in water may include one or more of an anionic surfactant and a nonionic surfactant. The anionic surfactant may include a sulfate, for example. The anionic surfactant may include a carboxylate, for example. The nonionic surfactant may include a glycol, for example. The carbon black may be, for example, Aquablak® 5106 (Solution Dispersions, Cynthiana, Ky.), Aquablak® 6950 (Solution Dispersions, Cynthiana, Ky.), Aquablak® 8361 (Solution Dispersions, Cynthiana, Ky.), or a combination thereof.

The elastomer may be present in the conductive cement composition in an amount in wt % of at least about one or more of: 45, 50, 55, and 60. The elastomer may be present in the conductive cement composition in an amount in wt % between any of the preceding values, for example, between about 45 and about 50, or between about 45 and about 55. The elastomer may be present in the conductive cement composition in less than about 45 wt %. The elastomer may be present in the conductive cement composition in greater than about 60 wt %. The elastomer may include an unsaturated polymer. The elastomer may include a synthetic rubber. The elastomer may include a natural rubber. The elastomer may include a latex. The elastomer may include polyisoprene, polybutadiene, polystyrene butadiene, or a combination thereof.

The curative may be present in the conductive cement composition in an amount in wt % of at least about one or more of: 2.7, 3.0, 3.3, 3.6, and 3.9. The curative may be present in the conductive cement composition in an amount in wt % between any of the preceding values, for example, between about 2.7 and about 3.6, or about 3.0 and about 3.3. The curative maybe be present in the conductive cement composition in less than about 2.7 wt %. The curative may be present in the conductive cement composition in greater than about 3.9 wt %. The curative may include sulfur. The curative may be elemental sulfur.

The accelerant may be present in the conductive cement composition in an amount in wt % of at least about one or more of: 0.1, 0.2, 0.3, 0.4, and 0.5. The accelerant may be present in the conductive cement composition in an amount in wt % between any of the preceding values, for example, between about 0.1 and about 0.2, or between about 0.2 and about 0.4. The accelerant may be present in the conductive cement composition in less than about 0.1 wt %. The accelerant may be present in the conductive cement composition in greater than about 0.5%. The accelerant may include one or more of: a thiazole, a guanidine, an aldehyde amine, a sulfenamide, a dithiocarbamate, a thiuram sulfide, a xanthate, and the like. The accelerant may include mercaptobenzothiazole disulfide (MBTS), for example.

The tackifying resin may be present in the conductive cement composition in an amount in wt % of at least about one or more of: 3, 5, 7, 9, and 11. The tackifying resin may be present in the conductive cement composition in an amount in wt % between any of the preceding values, for example, between about 5 and about 9, or between about 3 and about 5. The tackifying resin may be present in the conductive cement composition in less than about 3 wt %. The tackifying resin may be present in the conductive cement composition in greater than about 11 wt %. The tackifying resin may include one or more of: a rosin, a terpene resin, an aliphatic resin, a cycloaliphatic resin, an aromatic resin, a phenolic hydrocarbon resin, and the like.

The tackifying resin may be a solution in an organic solvent. The tackifying resin may be a suspension in an organic solvent. The organic solvent may be a hydrocarbon solvent, for example.

The tackifying resin may be a one or more of a suspension, a dispersion, and an emulsion in water. The tackifying resin as one or more of a suspension, a dispersion, and an emulsion in water may include one or more of an anionic surfactant and a nonionic surfactant. The anionic surfactant may include a sulfate, for example. The anionic surfactant may include a carboxylate, for example. The nonionic surfactant may include a glycol, for example. The tackifying resin may include Tacolyn™ 5070 (Eastman Chemical Co., Kingsport, Tenn.), for example. The tackifying resin may include Koresin® (BASF, Florham Park, N.J.), for example.

The conductive cement composition may include an essential oil. The essential oil may be present in the conductive cement composition in an amount in wt % of at least about one or more of: 1.3, 1.5, 1.7, 1.9, and 2.1. The essential oil may be present in the conductive cement composition in an amount in wt % between any of the preceding values, for example, between about 1.3 and about 1.9, or between about 1.3 and about 1.5. The essential oil may be present in the conductive cement composition in less than about 1.3 wt %. The essential oil may be present in the conductive cement composition in greater than about 2.1 wt %. The essential oil may include limonene. The essential oil may include one or more of orange oil, lemon oil, lime oil, grapefruit oil, and bergamot oil.

Conductive cement splice 114 may secure one or more of the set of tread ends 102 and the set of splice surfaces 108 together. The conductive cement composition may be contacted with an activator. The conductive cement composition may be applied to one or more of the set of tread ends 102 and the set of splice surfaces 108. The conductive cement composition may be painted onto one or more of the set of tread ends 102 and the set of splice surfaces 108. The conductive cement composition may be ejected from a container onto one or more of the set of tread ends 102 and the set of splice surfaces 108. The conductive cement composition may be poured onto one or more of the set of tread ends 102 and the set of splice surfaces 108.

Conductive cement splice 114 may be oriented only upon, and between, splice surfaces 108 such that conductive cement splice 114 at least partially bonds splice surfaces 108 to one another. Conductive cement splice 114 may be oriented only upon, and between, splice surfaces 108 such that conductive cement splice 114 does not extend into either of tread ends 102, but rather extends between tread ends 102. Conductive cement splice 114 may be oriented only upon, and between, splice surfaces 108 such that conductive cement splice 114 does not extend into the tread.

Conductive cement splice 114 of tire tread 100 may include a width W. Width W may extend in an axial direction of the tire. Width W may be substantially equal to a width W2 of tire tread 100. Width W may be less than width W2. Width W may be greater than width W2.

Conductive cement splice 114 may include one splice segment of width W extending along at least a portion of width W2 of tire tread 100. Conductive cement splice 114 may include more than one splice segment of width W extending along at least a portion of width W2 of tire tread 100. In the case where tire tread 100 includes multiple splice segments, the splice segments may be separated by voids. The voids may remain vacant prior to curing and allow for the set of tread ends 102 to join between the voids upon curing and molding of the tire tread. Alternatively, the voids may be filled with a different cement or rubber composition.

Conductive cement splice 114 of tire tread 100 may include a thickness. Thickness may extend in a circumferential direction of the tire (not shown). Conductive cement splice 114 may include a thickness in millimeters of at least about one or more of: 0.015, 0.030, 0.050, 0.100, 0.150, 0.200, 0.300, 0.400 0.500, and 0.600. Conductive cement splice 114 may include a thickness in millimeters between any of the preceding values, for example, between about 0.015 and about 0.150, or between about 0.100 and about 0.400. Conductive cement splice 114 may include a thickness less than about 0.015 mm. Conductive cement splice 114 may include a thickness greater than about 0.600 mm. Conductive cement splice 114 may include a thickness less than the entire circumference of the tire.

Conductive cement splice 114 of tire tread 100 may include an average force peak value of at least about 200 N. Conductive cement splice 114 of ire tread 100 may include an average force peak value of at least about 300 N. Conductive cement splice 114 may include an average force peak value in N of at least about one or more of: 150, 200, 250, 300, 350, 400, 450, 500, 550, and 600. Conductive cement splice 114 may include an average force peak value in units of N between any of the preceding values, for example, between about 200 and about 250, or between about 200 and about 300. Conductive cement splice 114 may include an average force peak value of greater than 600 N.

Generally, nonconductive materials are those including an electrical resistivity that prevents discharge of built up electricity. Materials are typically considered nonconductive materials when the material includes an electrical resistivity of between about 10⁸ Ω·cm and about 10¹¹ Ω·cm, or greater.

Generally, conductive materials are those including an electrical resistivity that permits discharge of built up electricity. Materials are typically considered conductive materials when the material includes an electrical resistivity of about 10⁸ Ω·cm or less. Electrical resistivity of conductive and nonconductive materials may be determined using a volume resistivity test. Electrical resistivity of conductive and nonconductive materials may also be determined using an ASTM D991 test. Electrical resistivity of conductive and nonconductive materials may be determined using a test including a probe, a test fixture, a resistance/current meter, a thermo-hygrometer, and a thickness gauge capable of reading to 0.0025 cm. A test sample of a conductive or nonconductive material may have dimensions of about 15.24 cm by 15.24 cm, by 0.254 cm. The test sample's thickness may be measured to the nearest 0.0025 cm in two places, which may be about 5.08 cm from the test sample's edge, along a line bisecting the test sample. The test sample's edges referenced in the measurement of thickness may be adjacent to one another and approximately 90 degrees to one another. The test sample is laid on a table for at least 1.0 hour at room temperature prior to taking resistivity measurements. The test sample may be oriented in the test apparatus such that the test sample's edge is aligned with the edge of a conductive plate, which conductive plate is connected via a probe to the resistance meter, all of which is below the test sample. The remaining three sides of the test sample may hang over the edges of the conductive plate evenly. A second probe may be connected to an input of the resistance meter, and may be placed on the top of the test sample, such that it is approximately on center with the conductive plate oriented beneath the test sample. Following placement of the test sample and probes in the test fixture, electrical resistivity may be measured via the resistance meter. In one embodiment, the probe and test fixture are verified prior to testing a test sample's resistivity.

Conductive cement splice 114 of tire tread 100 may include an electrical resistivity of less than about 9×10⁸ Ω·cm. Conductive cement splice 114 may include an electrical resistivity of less than about 9×10⁷ Ω·cm. Conductive cement splice 114 may include an electrical resistivity in units of Ω·cm of less than about one or more of: 9×10⁷, 8×10⁷, 7×10⁷, 6×10⁷, 5×10⁷, 4×10⁷, 3×10⁷, 2×10⁷, and 1×10⁷. Conductive cement splice 114 may include an electrical resistivity in units of Ω·cm between any of the preceding values, for example, between about 7×10⁷, and about 6×10⁷, or between about 4×10⁷ and about 2×10⁷. Conductive cement splice may include an electrical resistivity between about 1×10⁷ Ω·cm and about 9×10⁶ Ω·cm. Conductive cement splice 114 may include an electrical resistivity of less than about 9×10⁶ Ω·cm.

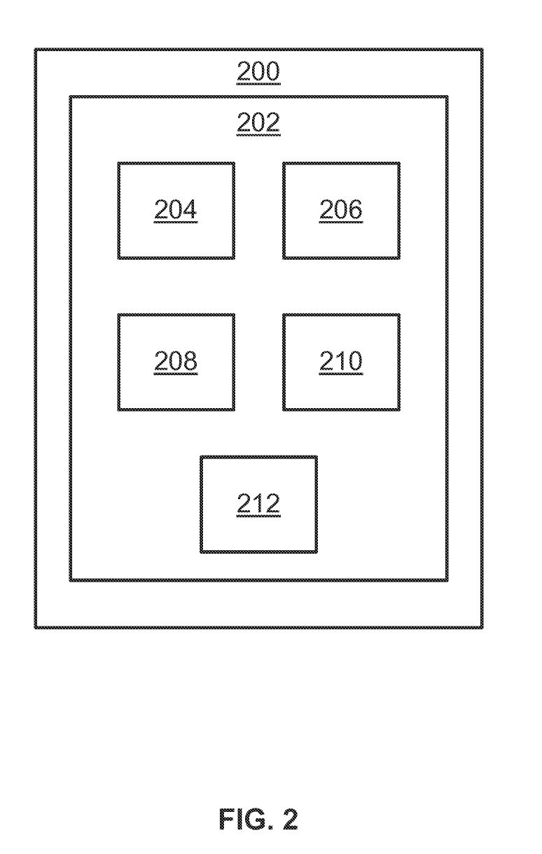

FIG. 2 illustrates a kit 200 including a conductive cement composition 202. In various embodiments, a kit 200 is provided. Kit 200 may include a conductive cement composition 202. Conductive cement composition 202 may include a carbon black 204. Conductive cement composition 202 may include an elastomer 206. Conductive cement composition 202 may include a curative 208. Conductive cement composition 202 may include an accelerant 210. Conductive cement composition 202 may include a tackifying resin 212.

Kit 200 may include one or more of carbon black 204, elastomer 206, curative 208, accelerant 210, and tackifying resin 212 in a single package or container. Alternatively, kit 200 may include one or more of carbon black 204, elastomer 206, curative 208, accelerant 210, and tackifying resin 212 in a separate package or container.

Conductive cement composition 202 may further include an organic solvent. The organic solvent may include a hydrocarbon solvent, for example. Conductive cement composition 202 may include water. Conductive cement composition 202 may include water and one or more of anionic surfactant and a nonionic surfactant. The anionic surfactant may include one or more of a sulfate, a carboxylate, and the like. The nonionic surfactant may include a glycol, for example.

Carbon black 204 may be any grade carbon black. Carbon black 204 may be any grade carbon black, for example, N134, N234, N330, N550, N660, N774, or N990 grade carbon black, or combinations thereof carbon black 204 may, for example, originate from Aquablak® 5106 (Solution Dispersions, Cynthiana, Ky.), Aquablak® 6950 (Solution Dispersions, Cynthiana, Ky.), Aquablak® 8361 (Solution Dispersions, Cynthiana, Ky.), or a combination thereof carbon black 204 may be present in conductive cement composition 202 in an amount in wt % of at least about one or more of: 25, 27, 29, 30, 32, 34, 36, 38, and 40. Carbon black 204 may be present in conductive cement composition 202 in an amount in wt % between any of the preceding values, for example, between about 27 and about 29, or between about 29 and about 36. Carbon black 204 may be present in conductive cement composition 202 in less than about 25 wt %. Carbon black 204 may be present in conductive cement composition 202 in greater than about 40 wt %. Carbon black 204 may be present in conductive cement composition 202 in an amount in phr of at least about one or more of: 25, 30, 35, 40, 45, 50, 55, 60, 65, 70, and 75. Carbon black 204 may be present in conductive cement composition 202 in an amount in phr between any of the preceding values, for example, between about 25 and about 40, or between about 35 and about 70. Carbon black 204 may be present in conductive cement composition 202 in less than about 25 phr. Carbon black 204 may be present in conductive cement composition 202 in greater than about 75 phr

Elastomer 206 may include an unsaturated polymer. Elastomer 206 may include a synthetic rubber. Elastomer 206 may include a natural rubber. Elastomer 206 may include a latex. Elastomer 206 may include polyisoprene, polybutadiene, polystyrene butadiene, or a combination thereof. Elastomer 206 may be present in conductive cement composition 202 in an amount in wt % of at least about one or more of: 45, 50, 55, and 60. Elastomer 206 may be present in conductive cement composition 202 in an amount in wt % between any of the preceding values, for example, between about 45 and about 60, or between about 45 and about 55. Elastomer 206 may be present in conductive cement composition 202 in less than about 45 wt %. Elastomer 206 may be present in conductive cement composition 202 in greater than about 60 wt %.

Curative 208 may include sulfur. Curative 208 may include elemental sulfur. Curative 208 may be present in conductive cement composition 202 in an amount in wt % of at least about one or more of: 2.7, 3.0, 3.3, 3.6, and 3.9. Curative 208 may be present in conductive cement composition 202 in an amount in wt % between any of the preceding values, for example, between about 3.0 and about 3.3, or between about 3.6 and about 3.9. Curative 208 may be present in conductive cement composition 202 in less than about 2.7 wt %. Curative 208 may be present in conductive cement composition 202 in greater than about 3.9 wt %.

Accelerant 210 may include one or more of: a thiazole, a guanidine, an aldehyde amine, a sulfenamide, a dithiocarbamate, a thiuram sulfide, a xanthate, and the like. Accelerant 210 may include mercaptobenzothiazole disulfide (MBTS), for example. Accelerant 210 may be present in conductive cement composition 202 in an amount in wt % of at least about one or more of: 0.1, 0.2, 0.3, 0.4, and 0.5. Accelerant 210 may be present in conductive cement composition 202 in an amount in wt % between any of the preceding values, for example, between about 0.1 and about 0.3, or between about 0.3 and about 0.4. Accelerant 210 may be present in conductive cement composition 202 in less than about 0.1 wt %. Accelerant 210 may be present in conductive cement composition 202 in greater than about 0.5 wt %.

Tackifying resin 212 may include one or more of: a rosin, a terpene resin, an aliphatic resin, a cycloaliphatic resin, an aromatic resin, a phenolic hydrocarbon resin, and the like. Tackifying resin 212 may include Tacolyn™ 5070 (Eastman Chemical Co., Kingsport, Tenn.), for example. Tackifying resin 212 may include Koresin® (BASF, Florham Park, N.J.), for example. Tackifying resin 212 may be present in conductive cement composition 202 in an amount in wt % of at least about one or more of: 3, 5, 7, 9, and 11. Tackifying resin 212 may be present in conductive cement composition 202 in an amount in wt % between any of the preceding values, for example, between about 3 and about 9, or between about 5 and about 7. Tackifying resin 212 may be present in conductive cement composition 202 in less than about 3 wt %. Tackifying resin 212 may be present in conductive cement composition 202 in greater than about 11 wt %.

Conductive cement composition 202 may include an essential oil. The essential oil may be present in conductive cement composition 202 in an amount in wt % of at least about one or more of: 1.3, 1.5, 1.7, 1.9, and 2.1. The essential oil may be present in conductive cement composition 202 in an amount in wt % between any of the preceding values, for example, between about 1.5 and about 2.1, or between about 1.3 and about 1.7. The essential oil may be present in conductive cement composition 202 in less than about 1.3 wt %. The essential oil may be present in conductive cement composition 202 in greater than about 2.1 wt %. The essential oil may include limonene. The essential oil may include one or more of orange oil, lemon oil, lime oil, grapefruit oil, and bergamot oil.

Kit 200 may further include at least one activator. The at least one activator may include an oxidizing agent. The at least one activator may include one or more of zinc oxide and stearic acid.

Kit 200 may include one or more of carbon black 204, elastomer 206, curative 208, accelerant 210, tackifying resin 212, and the essential oil in a single package or container. Alternatively, kit 200 may include one or more of the carbon black 204, elastomer 206, curative 208, accelerant 210, tackifying resin 212, and the essential oil in a separate package or container. Kit 200 may include the at least one activator in a package or container with one or more of carbon black 204, elastomer 206, curative 208, accelerant 210, tackifying resin 212, and the essential oil. Alternatively, kit 200 may include the at least one activator in a package or container without any one of carbon black 204, elastomer 206, curative 208, accelerant 210, tackifying resin 212, and the essential oil.

Kit 200 may include instructions. The instructions may direct a user to contact conductive cement composition 202 with at least one activator to obtain a mixture. Contacting conductive cement composition 202 with the at least one activator may include mixing. The instructions may direct a user to apply the mixture to two or more articles. The instructions may direct a user to contact the two or more articles. The instructions may direct a user to apply to the contacted articles one or more of heat and pressure for a period of time.

### EXAMPLES

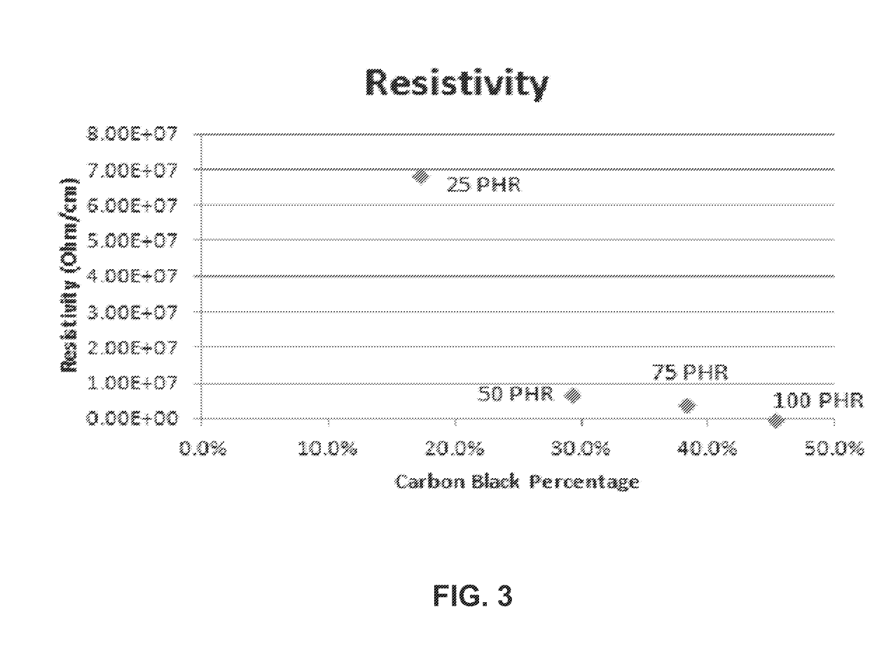

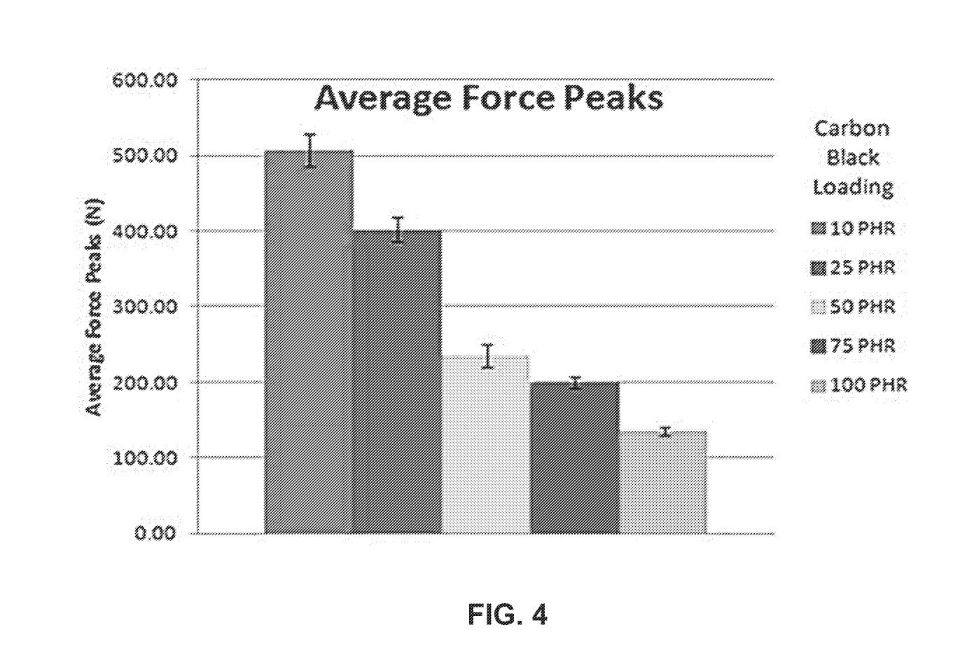

The following examples illustrate the properties of example conductive cement compositions. The conductivity of the conductive cement composition increases (resistivity decreases) with increasing amounts of carbon black present in the conductive cement composition, as illustrated in the graph of FIG. 3. The degree of adhesion, determined by average force peak values (AVFP), decreases with increasing amounts of carbon black present in the conductive cement composition, as illustrated in the graph of FIG. 4.

The conductive cement samples were prepared by weighing all liquid components into a flask and manually agitating the solution. To the solution was added all solid components (i.e., sulfur and MBTS) and the mixture was further agitated.

The resistivity values of the conductive cement compositions were determined by drying each conductive cement sample on a flat surface and placing digital multimeter (DMM) probes about 1 cm apart. Current was passed through the conductive cement sample and the resistivity values were measured per cm unit.

The average force peak values (AFPV) of the conductive cement samples were determined by a strip adhesion test. A 2.54 cm wide sample was prepared and a woven nylon mesh (Sefar Nitex) was placed at the interface of the sample. The samples were cured and subjected to a 50.8 mm/min extension rate displacement.

### Example 1: Conductive Cement Composition with 10 Phr Carbon Black

At 10 phr carbon black, the resistivity was too high to obtain a measurement. Thus at 10 phr carbon black or less, the conductive cement composition exhibits little to no conductivity. At 10 phr carbon black, the AFPV was measured at about 500 N. The 10 phr carbon black composition included 73.4% latex, 10.7% carbon black, 8.8% tackifying resin, 4.4% sulfur, 2.2% orange oil, and 0.4% MBTS. The percentages are based upon weight of the liquid components. The phr value was determined by dry weights.

### Example 2: Conductive Cement Composition with 25 Phr Carbon Black

At 25 phr carbon black, the resistivity was measured at about 7×10⁷ Ω·cm, and the AFPV was measured at about 400 N. The 25 phr carbon black composition included 63.2% latex, 23.1% carbon black, 7.6% tackifying resin, 3.8% sulfur, 1.9% orange oil, and 0.4% MBTS. The percentages are based upon weight of the liquid components. The phr value was determined by dry weights.

### Example 3: Conductive Cement Composition with 50 Phr Carbon Black

At 50 phr carbon black, the resistivity was measured at about 0.8×10⁷ Ω·cm, and the AFPV was measured at about 230 N. The 50 phr carbon black composition included 51.3% latex, 37.6% carbon black, 6.2% tackifying resin, 3.1% sulfur, 1.5% orange oil, and 0.3% MBTS. The percentages are based upon weight of the liquid components. The phr value was determined by dry weights.

### Example 4: Conductive Cement Composition with 75 Phr Carbon Black

At 75 phr carbon black, the resistivity was measured at about 0.3×10⁷ Ω·cm, and the AFPV was measure at about 200 N. The 75 phr carbon black composition included 43.2% latex, 47.4% carbon black, 5.2% tackifying resin, 2.6% sulfur, 1.3% orange oil, and 0.3% MBTS. The percentages are based upon weight of the liquid components. The phr value was determined by dry weights.

### Example 5: Conductive Cement Composition with 100 Phr Carbon Black

At about 100 phr carbon black, the resistivity was measured at less than about 0.1×10⁷ Ω·cm, and the AFPV was measured at about 130 N. The 100 phr carbon black composition included 37.3% latex, 54.6% carbon black, 4.5% tackifying resin, 2.2% sulfur, 1.1% orange oil, and 0.2% MBTS. The percentages are based upon weight of the liquid components. The phr value was determined by dry weights.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A conductive cement composition comprising:
a carbon black;
an elastomer;
a curative;
an accelerant;
a tackifying resin; and
one or more of: water, an anionic surfactant, and a nonionic surfactant.

2. (canceled)

3. The conductive cement composition of claim 1, the carbon black including one or more of: N330 grade carbon black, Aquablak® 5106, Aquablak® 6950, and Aquablak® 8361.

4. The conductive cement composition of claim 1, the carbon black being present in an amount in wt % between about 25 and about 40.

5-6. (canceled)

7. The conductive cement composition of claim 1, the elastomer being present in an amount in wt % between about 45 and about 60.

8. The conductive cement composition of claim 1, the curative including sulfur.

9. The conductive cement composition of claim 1, the curative being present in an amount in wt % between about 2.7 and about 3.9.

10. (canceled)

11. The conductive cement composition of claim 1, the accelerant including MBTS.

12. The conductive cement composition of claim 1, the accelerant being present in an amount in wt % between about 0.1 and about 0.5.

13. (canceled)

14. The conductive cement composition of claim 1, the tackifying resin including Tacolyn™ 5070.

15. The conductive cement composition of claim 1, the tackifying resin being present in an amount in wt % between about 3 and about 11.

16. The conductive cement composition of claim 1, further comprising an essential oil, the essential oil including one or more of: orange oil, lemon oil, lime oil, grapefruit oil, and bergamot oil.

17. The conductive cement composition of claim 16, the essential oil being present in an amount in wt % between about 1.3 and about 2.1.

18. A tire tread (100) comprising:
a set of tread ends (102);
a road-contacting surface (104);
an inner component-contacting surface (105) substantially opposite the road-contacting surface (104);
a set of splice surfaces (108) terminating the set of tread ends (102);
a lateral outer edge (110) and a lateral inner edge (112); and
a conductive cement splice (114) including a conductive cement composition including a carbon black;
wherein the conductive cement splice (114) extends at least partially from the lateral outer edge (110) to the lateral inner edge (112); and
wherein the conductive cement splice (114) secures one or more of the set of tread ends (102) and the set of splice surfaces (108).

19. The tire tread (100) of claim 18, wherein the conductive cement splice (114) extends from the road-contacting surface (104) to the inner component-contacting surface.

20. The tire tread (100) of claim 18, further comprising:
a pattern including one or more of at least one tread rib and at least one tread block (116);
wherein one or more of the at least one tread rib and the at least one tread (116) block includes a radially outermost portion (120); and
wherein the conductive cement splice (114) extends to the radially outermost portion (120).

21. The tire tread (100) of claim 18, the carbon black being present in an amount in wt % between about 25 and about 40.

22. The tire tread (100) of claim 18, the conductive cement splice (114) including an average force peak value of at least about 300 N.

23. The tire tread (100) of claim 18, the conductive cement splice (114) including an electrical resistivity of less than about 7×10⁷ Ω·cm.

24. A kit (200) comprising:
a conductive cement composition (202) including:
a carbon black (204);
an elastomer (206);
a curative (208);
an accelerant (210);
a tackifying resin (212); and
at least one activator.

25. The kit (200) of claim 24, the conductive cement composition (202) further comprising an essential oil.

26. (canceled)
